(19) United States
(12) Patent Application Publication
(10) Pub. No.: US 2003/0212589 A1
(43) Pub. Date: Nov. 13, 2003

(54) Enhancement incentive system using transaction events for user rewards, for workforce productivity on a distributed network

(76) Inventor: William Elmer Kish, Moraga, CA (US)

Correspondence Address: William E. Kish, 1738 ST. Andrews Drive, Moraga, CA, 94556, US

(21) Appl. No.: 10/144,138

(22) Filed: May 13, 2002

(51) Int. Cl. G06F 17/60

(52) U.S. Cl. 705/9

(57) ABSTRACT

An Integrated Service System (ISS) providing infrastructure for employee empowerment and customer incentives. An employee assignment is the embodiment of the system using the system to provide specific employees with the allocation of Work Order assignments with a specific amount of points wherein the points have company value. Sponsor Company uses the entire system or part of the system to assign employees to the Work Order. The system provides employee empowerment, recognition, maximizes the productivity of human capital and capital assets which reduces company cost. It promotes employee advancement which the system empowers employee to acquire additional company skills through the system modules. It places responsibility of company resources on employees wherein utilization is measured by work order performance. Therefore good performance is a benefit and the benefits should reduce the company total cost of ownership in the workforce or specific work orders.

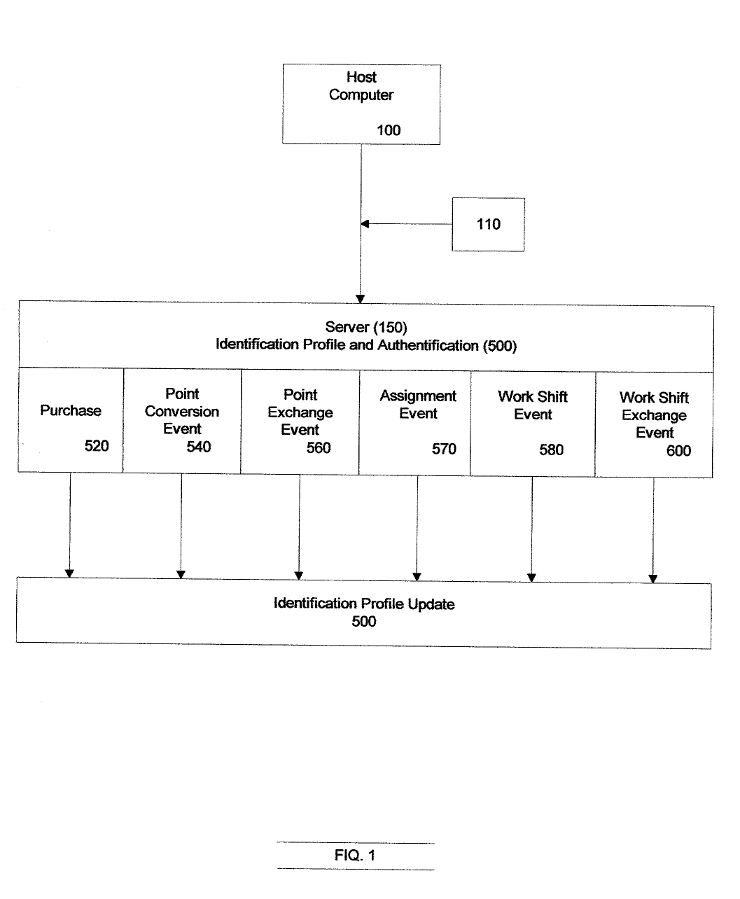

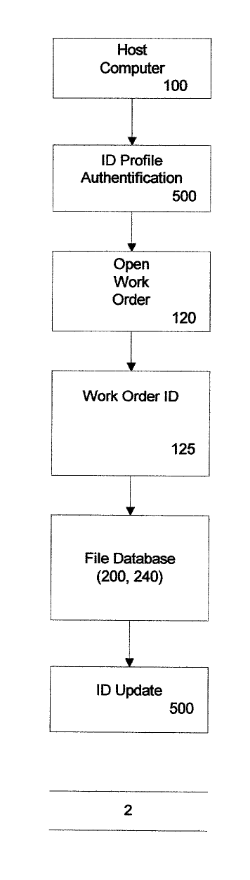

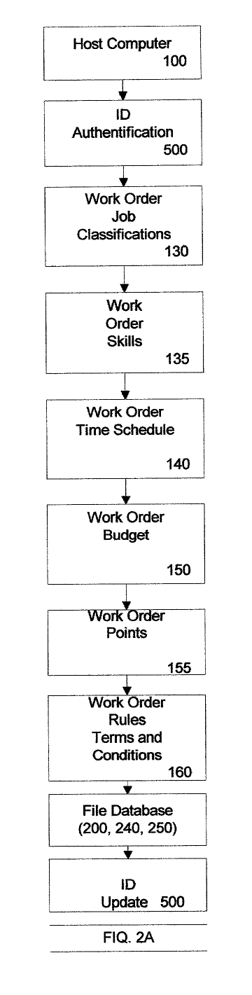

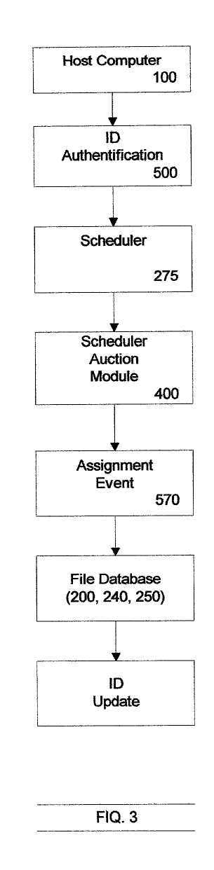

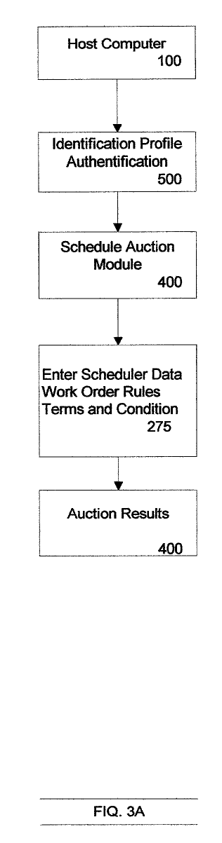

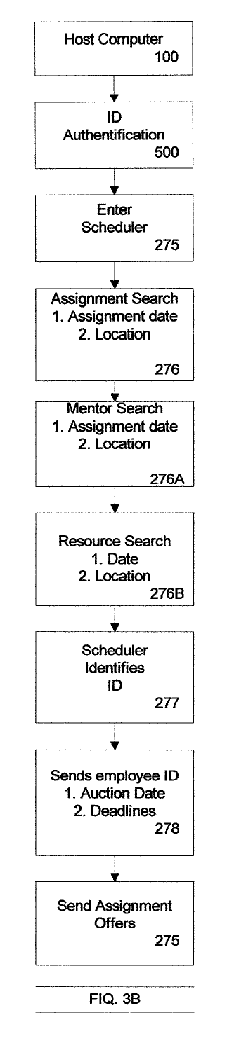

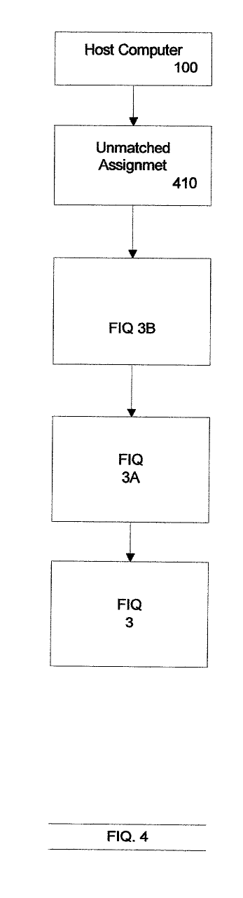

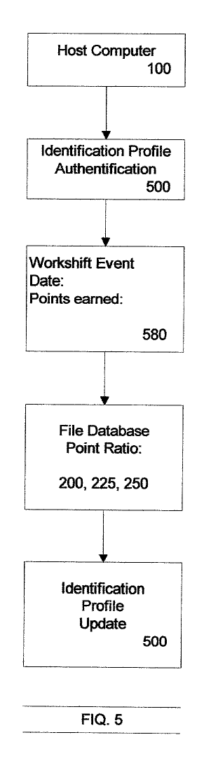

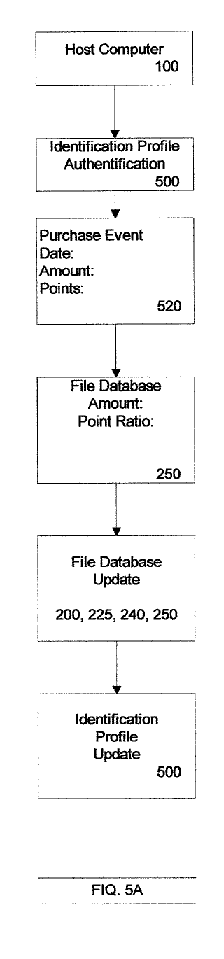

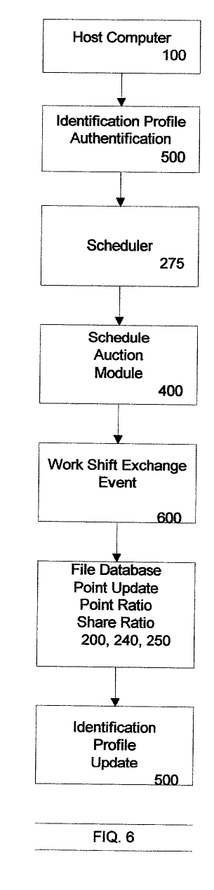

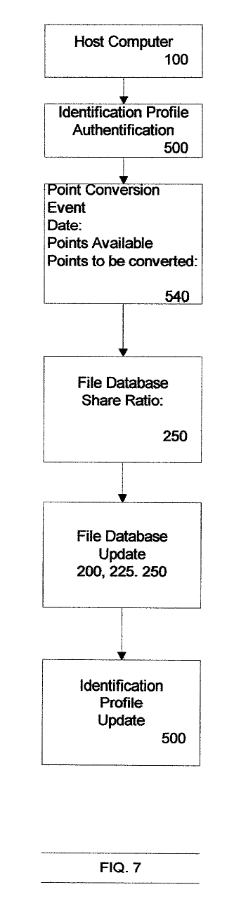

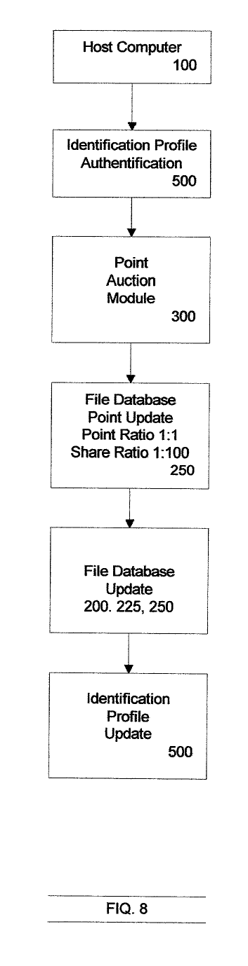

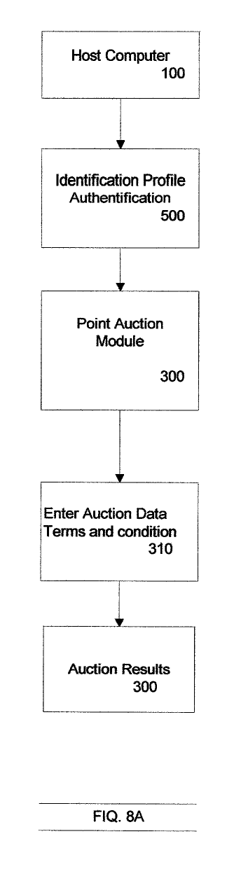

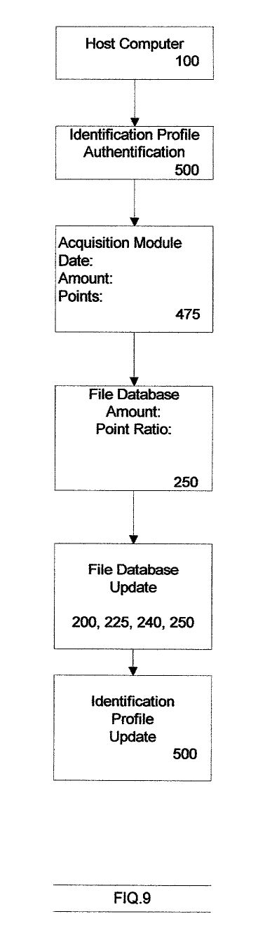

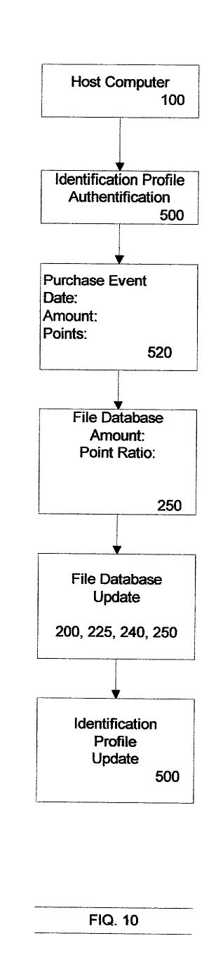

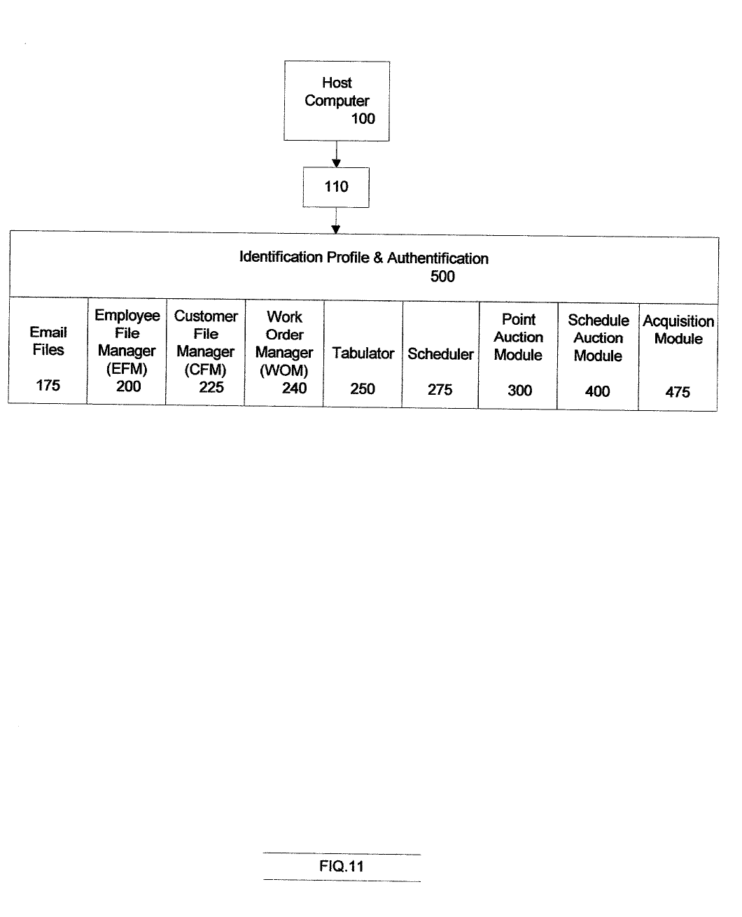

### FIELD OF TECHNOLOGY

The present invention consist of the methods and apparatus for effecting communication between employees and between companies who supply and customers who purchase the goods and services the sponsored company provides. Individual gain is enhanced through the use of application such as auctions, scheduler, resource management, databases, wherein the user upon completion of a successful work assignment, receives points for a unit value wherein the unit has value. The present invention provides employees and company consultants, company approved vendors and company customers with an opportunity to improve productivity by participating in the sponsored company assignment and work orders. Company is provided with the benefit of workforce efficiency wherein the company receives greater employee productivity from lower project cost.

### BACKGROUND OF THE INVENTION

Business enterprises most valuable asset is the workforce. The workforce in the 21^{st} century has changed in many ways accelerated by workstations, networking and mobile communication within facilities and remote sites. Workers have become knowledge workers where companies train employees on a continuous improvement program. The workforce change has transcended the 8 hour shift from 9 to 5 and substituted flexible work shifts based upon employee skills and work shift results. Over the past decade from 1990, productivity gains have been improving, where companies have used systems to service customers called customer relationship management (CRM) and systems reducing manufacturing cost called supply chain management (SCM). The Internet connects the customer and the suppliers with the business enterprise.

Employees having more responsibility today and they are requested by managers to assume more tasks as companies must maintain competitive market positions. Product pricing is intense in most industries and companies are forced to reduce cost. The major cost in most businesses is labor. Information Technology (IT) has deployed systems based upon Enterprise Resource Planning (ERP) where human resource benefits, payroll, fulfillment, administration, resource management and scheduling are self service for employees where employee access employee portals. A knowledge workforce becomes efficient minimizing business overhead cost.

Human capital life cycle for the knowledge worker requires continuous improvement by training for potential job advancement opportunities. Employee empowerment using company training programs create employee opportunity for those improving skills.

The system provides an enhanced incentive for senior managers, middle managers and employees wherein senior management can redirect manager's resources and provide greater opportunity for the sponsored company.

Many industries spend up to $15,000 annually in resources to support a single employee. Computer, software, networking equipment, test measurement, office supplies, conference facilities, fleet vehicles, are resources which the system addresses.

Today, employees are provided management tools wherein they can request needs through product orders, route their needs to the appropriate approval manager wherein the purchase manager has an approved list of suppliers for company supplies and infrastructure. These systems are well known in the art and these systems prevent maverick buying.

Business enterprises have collaborated with their trading partners to plan and execute to meet customer demand creating greater efficiency and cost savings. The supply chain efficiency allows better planning and better processing of goods and services. Knowledge management enables businesses to analyze, organize the products from supplier catalogs across the business enterprise and to route the product to the procurement and transaction event. Supply chain management eliminates duplication and it reduces capital expenditures. There are performance standards where the business enterprise can measure and evaluate suppliers. Suppliers providing outsourcing in manufacturing, commodities in the production of goods. Reporting is well known in the art as benchmarking against contracts and commitments.

Benchmarking employee is used to evaluate employees for promotion, demotion, assignment, training and job responsibilities. Companies are required by federal law to provide documentation on reliability and validity of this status. Evaluation tools including questionnaires designed to elicit responses are largely ineffective since they often yield results that are unreliable. Therefore, there is a need in the art for an improvement in measurement, evaluating an employee and his and her contribution to the business success. Pay range is used in business where employee competencies are determined base upon a pay level. The employee is evaluated in a process as a performance review and a senior employee may be rewarded at the high end of the pay range. Other company evaluations are subjective and not empirical, and not objective where many companies use checklist with alpha and beta ratings.

Other benchmarking techniques include 360-degree evaluation processes. The process of implementing the 360 plan provides the key needs, information, employee development and employee accountability the company desires. The goal is communicating to all levels of the company the business elements of strategy and competitiveness. Employee training in appraisal processes, employee feedback techniques, and learning to receive feedback.

### Definitions

The term “Authentication” as used herein, encompasses multiple authentication schemes via Authentication Servers, LDAP Directory Servers, Firewall Secure Servers, Content Security, Virtual Private Network Appliances, and computers under the control of software for the purpose of authentication, protection against external and internal attacks, viruses, undesirable URL and more.

The term “auction” as used herein encompasses any sponsor company transaction which include assignments, work shift, merchandise, points, and equity shares.

The term “consumer,” as used herein, encompasses any individual or user who wishes to participate in awards or incentive programs offered by sponsor company and its units. Consumers may be employees of the sponsor company where the employee is working in a Unit, or may be customers of the sponsor company merchandise supplier.

“Employee” is a user who has signed an employee agreement with the company or a subscription agreement with the company allowing said employee the right to use the company's systems. The word employee can mean a company using a company's system as a contract employee or contract consultant wherein this said contract employee has signed a contract or subscription agreement with the company to permit the use of the company's system. The employee is assigned an Identification Profile (ID) which the ID empowers the employee to exchange points and work shifts, and to access the customer database. Point rewards are adjusted to the level of work performed. The employee having an ID, said ID is updated when transaction events occur.

“Points” are units, which the units have value. The point having a unit value wherein the unit value can be converted to cash, merchandise, and equity. The conversion is defined by the sponsored company policy. Sponsored company may convert to equity or the sponsored company may use said point as a measurement for employee productivity and for employee recognition. Sponsored company can use performance measurement where the employees can be monitored by their accumulated points.

The term “server” as used herein encompasses a computer offering a service to another computer, which could be a dedicated machine, appliance server, application computer, email server, web server, web server software, database servers and client software.

The term “under the control of software components” as used to receive, send, direct, and route and not limited to transaction events, results, update, record, and store the data from and server, appliance, database or any type of computer system.

Scheduler: Scheduler and Asset Management are referred in this work as one wherein both provide the availability of work order requirements of employees and sponsored company resources. The system provides work assignment, work shift and resource availability. They are combined to access employees for assignment, work shifts, and to include the company equipment, software, facilities and services.

Asset Management identifies capital equipment, lab, offices within and outside the sponsored company or enterprise and Asset Management can identify resources which are own and leased. Asset Management provides the system with resource discovery with requirement for use to fulfill the Work Order based upon sponsored company request of class, type, serial number, asset tag or other description.

The term “Sponsor Company,” as used herein, encompasses any company that wishes to offer the ISS as an employee empowerment program.

The term “unit”, further describes the use of points as a reward which said point is an <option equal to a ratio of points to shares or ratio to cash, and converted at a certain anniversary date.

The term “Web server,” as used herein, encompasses any data processing system on which application programs and Internet sites may be stored for access and processing by the sponsored company computers. The Web server employs a customer relationship management application, control manager, web browser that allows for multimedia presentation of information, text, images, sound and video streaming.

Work Order Identification Profile (ID) is comprised of the Work Order inception date, point value, company classification which classification is a department, division, or region.

The Work Order Manager (WOM) is a database composed of the Work Orders, when queried by their Work Order ID, the database provides the Rules, Terms & Conditions, Points, and Budget. Open Work Order can exchange users during the term of the Work Order. It is the record of assignments, work shift changes, and resource assignments.

Tabulator is the database used for point values, ratios, other company HR incentives for sponsored company rewards.

Work Order Skills are skills where the skills are exact qualifications. Qualifications are skills wherein the employee or consultant has completed with the approval of the sponsored company wherein the required course, time, education, transferred ability, or said skill have been completed and approved by the sponsored company.

Work Order Time Schedule is the number of work shifts, assignment for each segment of the Work Order. Work Order may be part of a day or part of a decade for the sponsored company research and development and engineering projects.

Work Order Budget is the projected cost of the project. It is sum of each segment of the Work Order wherein employees, consultant, company resources are separated, staged, grouped, allocated and published by the sponsored company.

Work Order Points are assigned to work shifts, work assignment, software, equipment, computer network, consultant, wherein the points are the total cost of the Work Order.

Work Order Rules, Terms & Conditions wherein the Work Order is approved. Terms are company policies and procedures and Conditions are employment standards and best practice. Employees are open to engage and are able to fulfill assignments using the system.

### DETAIL DESCRIPTION OF THE DRAWINGS

FIQ. 1 is a schematic block diagram illustrating the system for user incentive transaction events.

FIQ. 2 is a schematic block diagram illustrating the Work Order wherein the Work Order is open by the project manager.

FIQ. 2A is a schematic block diagram illustrating the Work Order wherein the Work Order is defined within the sponsored company workforce.

FIQ. 3 is a schematic block drawing illustrating the assignment event.

FIQ. 3A is the schematic block diagram illustrating the Schedule Auction Module.

FIQ. 3B is a schematic block diagram illustrating the Scheduler.

FIQ. 4 is the schematic block drawing illustrating the unmatched assignments.

FIQ. 5 is a schematic block diagram of the Work Shift Event Module.

FIQ. 6 is the schematic block diagram illustrating the Work Shift Exchange Module.

FIQ. 7 is a schematic block diagram illustrating Point Conversion Event Module.

FIQ. 8 is a schematic block diagram illustrating the Point Exchange Module

FIQ. 8A is a schematic block diagram illustrating the Point Auction Module.

FIQ. 9 is a schematic block diagram illustrating the Acquisition Module.

FIQ. 10 is a schematic block diagram illustrating the Purchase Event Module.

FIQ. 11 is a systematic block diagram illustrating the Integrated Service System server, modules and databases.

### SUMMARY OF THE INVENTION

The invention engages management to produce a product or service at lower cost. This achievement in productivity is caused by ISS employee assignment Scheduler Auction. The Auction is used for many reasons wherein the auction by its very nature, defines cost effective bids for short or long term assignments. Best practice used by the sponsored company for qualified bids where skilled employees seeking work assignments for pay, skill advancement, and reward. The ISS enables employees to produce on schedule by exchanging work shifts using auction and by using incentives. Incentives are used which are points offered by the sponsored company wherein each assignment is separated by task and each task by work shift. Work shifts and assignments are exchanged by an auction wherein employees' exchange said points. The ISS provides work force availability and company resource available by the Scheduler and asset management.

ISS engages an open assignment for the workforce by work orders. Project management may assign key employees for key assignments while the Scheduler Auction is used for qualified employees whose schedules are open and whose skills may require improvement. Completed work assignments improve employee job classification and the company knowledge base.

ISS engages management by allocated the most efficient use of company assets wherein the resources are identified and allocated to company departments, divisions at the lowest cost of ownership.

The invention produces employees who deliver assignments with the best result and produces an improving skilled and effective workforce.

### DESCRIPTION OF THE PREFERRED EMBODIMENT

In FIQ 1, is a systematic drawing of the system using a Host Computer 100, which is the preferred embodiment of the invention, the system is an IBM PC compatible operating the Solarius operating system, wherein the system is limited and can operate using Oracle, IBM or Microsoft XP operating systems and the Server System 150 configured as a Web Server providing access. The Host Computer 100 software using Netscape Communicator or Microsoft Internet Explorer, the PC is capable of accessing the system, which is composed of web pages, which is well known in the art.

FIQ 1 shows a diagram of the system for user incentive transaction events in accordance with the preferred embodiment of the present invention. The system is not limited and an APPLE Macintosh system or a more advance computer system such as an Alpha based computer system available from COMPAQ Computer Corporation or SPARC station computer system available from SUN Microsystems, Corp. may be used. “Unit” terminals using scanning techniques which systems and methods are well known in the art provide a business with a local Host Computer.

Preferable the communication channel 110 is TCP/IP based network such as the Internet or an Intranet, although almost any well known LAN, WAN, VPN technology can be used. Users can exchange messages with enclosures such as files, graphics, video and audio. The system also supports multiple languages. Alternatively, network interface may be configured as voice and voice over IP.

FIQ. 1 is a drawing illustrating the system which provides the user, the access using a Host Computer 100 by a user Identification Profile 500 wherein the user has been authenticated by the Server 150. Authentication is the verification of a user's claimed' identity which the user logs into the system which is well known in the art. A password is the preferred embodiment where the user can access the system. The user has a Public Key Identification where the PKI is stored a server database. The user PKI includes the subscription agreement and or company policy which includes the users name, address, phone number, email address, inception date and user classification. There are authentication structures as Pretty Good Privacy, X.500, x.509 and someone well know in the art can appreciate other methods and systems.

The server under the control of software components creates transaction events for reward enhancement. The transaction events are user requirements based upon a user subscription agreement or company employment policies which the agreement requirements define user incentives. A Purchase Event 520, Point Conversion Event 540, Point Exchange Event 560, Assignment Event 570, Work Shift Event 580, and Work Shift Exchange Event 600 are recorded and stored in the file databases in the Server. The user Identification Profile is updated by each transaction event.

FIQ 2 is a schematic drawing of the Work Order wherein the Work Order is open by the project manager. The project manager having an Identification Profile 500, which is created upon employment using the sponsored company's policies and includes the employment date, units, points, equity and job classification. The Work Order ID can be numeric and alpha or a combination of each which said ID is known and is available to all employees. Record of the value of said points, units, shares are recorded and stored in the system database known as the Tabulator. Value is known on each transaction event.

Open Work Order 120 is opened by the project manager using his ID wherein the Work Order is assigned an ID 125. The sponsored company Work Order is comprised of the inception date, division, department, points and classification. The Work Order ID is filed in the Employee File Manager 200 and Work Order Manager 240 wherein the records are stored and the each ID is updated.

FIQ. 2A is a schematic drawing of the Work Order wherein the Work Order is defined within the sponsored company workforce. Work Order Job Classification 130 wherein the company separates all work shift jobs and the company identifies all Work Shift Skills 135. The Work Order Time Schedule 140 has a starting date and a completion date wherein all classifications of assignments, and work shifts are scheduled. Work Order Budget 150 combines all projected cost wherein are assignments, work shifts and company resources needed for completion of the Work Order. Work Order Points 155 are point rewards which are allocated to each assignment and work shift. Work Order Rules, Terms and Conditions 160 are the sponsored company policies.

It is recorded and stored in the database, which includes the Employee File Manager 200. Work Order Manager 240, and the Tabulator 250. Identification Profile is recorded, updated and stored.

FIQ 3 is a schematic drawing of the assignment event wherein the system employs a Scheduler 275 and the Scheduler Auction Module 400. The Assignment Event 570 provides specific employees with their work order assignments with the allocation of points. Assignments are assets and resources wherein the Assignment Event provides the Work Order with company assets of equipment, software and services.

The Assignment Event is not limited to work shifts but includes company resources identified in the Work Order, and includes the equipment, software, network associated with the successful completion of the Work Order.

The event is recorded and filed in the sponsored company database 200, 240, 250. The Identification Profile 500 is updated.

FIQ 3A is a schematic drawing of the Schedule Auction Module 400 wherein the Assignments offered are bid by employees. Employees use the Module to acquire their assignments.

Each Work Order assignment is offered with the Work Order ID wherein the company has offered its Work Order Rules, Terms and Conditions. Bidders are employees, consultants wherein they enter their bids in the Scheduler Auction Module. The Auction offers the assignments, and resources request wherein the auction process is well known in the art.

FIQ. 3B is a schematic drawing of an assignment request which the request is sent from the Scheduler to available users.

The Scheduler is an enterprise scheduler well known in the art. The preferred embodiment application is Simplex eFORCE that automatically generates and sorts employee work schedules by job and skill classifications enterprise-wide. A user from a host computer 100 request for job classification, mentor, and skill search 276 defining the date and location of the work. The Scheduler identifies employee 277 by the ID, mentor, skill and employee availability. Other schedulers as Kronos Smart Scheduler which workforce management is well known in the art can generate and sort work shift candidates. The user offering a request for a specific work shift change and the Scheduler identifying qualified work order users based on the ID and the employee schedule. The Scheduler provides a list of qualified employee and resources 278 and sends the list to the email directory or email server for employee notification, wherein the email has the work order auction date, terms and conditions. The Scheduler sends the request to the Scheduler Auction which includes the terms and conditions of the Work Order Offer. The Work Order ID is updated.

The Scheduler uses asset management wherein the preferred embodiment is MainControl. Work Order' resources are selected by a Work Order ID and resources are queried by using Asset Management.

FIQ. 4 is the schematic drawing for Unmatched Assignment 410, work shifts and resources within a Work Order. The system will repeat itself until all assignments have been fulfilled.

FIQ. 5 is a schematic block diagram of the Work Shift Event wherein the diagram describes the system recording the employee work shift. The user is awarded points for completing part of the assignment with the completion of a work shift 580. The sponsored company assigns a value to each work shift wherein the employee is awarded a certain amount of points. The work shift having a date and points value wherein the employee fulfills the transaction event and the event is recorded in the file database with the reward amount. The ID is updated 500 and the points are updated in the database 200, 240 and 250.

FIQ. 6 is a schematic block diagram of the Work Shift Exchange Event 600 wherein a user employs a Scheduler 275 for work shift scheduling data, and a Schedule Auction Module 400 for exchanging work shifts. T he Scheduler provides the Schedule Auction Module with the inquiry of a work shift exchange date. The Schedule Auction Module based upon the ID 500 executes the exchange between bidder and seller and the bidder and seller point exchange. The user ID is updated and stored in the database.

The system provides user account values known in the Tabulator Database 250 wherein all transaction events are of point, unit and share transactions are stored. The Ratio is stored in the Tabulator. The Ratio provides the exchange value of points to units and to shares.

FIQ. 7 is a schematic block diagram of the Point Conversion Event Module wherein the points are converted to units or shares and units or shares are issued to the user by the sponsored company. The user converts available points by the Point Conversion Event Module 540 using the Tabulator's 250 Ratio. The Tabulator has the ratio of points to unit or share price and in this example it is 100 points for 1 share where 1 share equals 5 dollars) and the Point Conversion Event is recorded in the databases and the user ID is updated.

FIQ. 8 is a systematic block diagram of the Point Exchange Event Module 560 wherein a user can exchange points using the Point Auction Module 300 which is well known in the art. The user having an ID can exchange points with other users having an ID 500. The point exchange is recorded in the file and stored in the databases 200, 225. The Ratio is stored in the Tabulator and the points are update in the Tabulator 250. The ID is updated.

FIQ. 8A is a systematic block diagram of Point Auction 300 wherein the auction is well known in the art. The user can exchange points by entering data on the Point Auction Module 300. The user may want to buy or sell points. The event is an exchange of points for cash, points for product, points for service. There is a buyer and a seller using the ID. The Auction Results are sent to the Point Exchange Event Module.

The preferred embodiment is Oracle 8I Exchange Marketplace Platform, wherein the user is a qualified bidder or seller of points, units and equity. The auction platform is an ecommerce tool that is well known in the art. The auction use in the preferred embodiment is a seller auction where points are offered. Reverse auctions are used which is a buyer wishes to sell points and the buyer issues a request for quote (RFQ) to a large number of sellers. The optimal bid is usually the highest point value.

FIQ. 9 is a schematic block diagram of the Acquisition Module 475 wherein the user using the Host Computer 100 accesses the system based upon an ID. The acquisition event is a work order resource request wherein the Scheduler or Asset Management approves the purchase of a product or service which the said product or service is necessary for the Work Order. The sponsored company's policy of invoice, purchase request and payment is required and it is well known in the art.

The preferred embodiment of the Acquisition Module is MainControl wherein the module uses requisition, purchase order and invoice mechanisms and assigns the cost to a specific department. Other Asset Management module as Peregrine's Asset Center will provide equipment, systems, and specification discovery by serial numbers, ID and other codes and is readily apparent to those skilled in the art. The linking from the server or a processor connected to the server with a PO number or other authority. Business to business purchases over the Internet is aimed at organizations buying and selling over the Internet using OBI; Open Buying On The Internet. The architecture is designed for a Requisitioner, Buying Organization, Selling Organization and Payment Authority. The Acquisition Module is between the buyer and the seller.

The acquisition has a known value and amount wherein the amount is awarded to the seller. The employee or user and department have a cost assigned to the Work Order. The approved vendor sale wherein the vender having an ID and having the opportunity to acquire points, said points are converted by the Point Ratio which the ratio is stored in the Tabulator database. The event is filed and stored in the database. The ID is updated.

FIQ 10 (5) is a schematic block diagram of the Purchase Event Module wherein the user using the Host Computer 100 accesses the system based upon an ID. The purchase event 520 is a purchase of the sponsored company product or service by a billing method, credit card or currency that is well known in the art.

The preferred embodiment of the Purchase Event Module uses payment mechanisms in a sponsored company or “Unit” through a secured use of an existing credit and debit-card payment infrastructure, billing and payment method which is readily apparent to those skilled in the art. The linking from the server or a processor connected to the server with a credit card clearinghouse or other authority. Non-Credit-Card and other methods using electronic cash such as CyberCoins and DigiCash which are stored on a smart card such as Mondex and Visa Cash are well known in the art. The process known as SSL developed by Netscape is a de facto standard for encrypting data sent between a user' browser and the merchant server. Business to business purchases over the Internet is aimed at organizations buying and selling over the Internet using OBI; Open Buying On The Internet. The architecture is designed for a Requisitioner, Buying Organization, Selling Organization and Payment Authority. The Purchase Event Module is the transaction event between the buyer and the seller wherein the seller is the sponsored company.

The purchase has a known value and amount wherein the purchase is recorded in the Customer File Manager (CFM), and Work Order Manager (WOM) which said purchase has in part or the entire benefit. The amount is converted by the Point Ratio, which the ratio is stored in the Tabulator database. The event is filed and stored in the database. The ID is updated.

FIQ. 11 is a systematic block diagram of the server, modules and databases of the Integrated Service System. The Host Computer 100 wherein is remote or in the “Unit”. The Host Computer can be wireless, wireline and it is connected to the Server and the user gains access by the Identification Profile. The server wherein is a computer process unit, web server or central processing unit wherein the computer is in the control of software components directing modules, and databases. Email File 175 are storage files of all users using electronic mail and the preferred embodiment is Critical Path Messaging Server. The directory has a list of employees which the directory is controlled by ID. This enables the Messaging Server and Message Boards for communication of auction for assignment, work shift, points and equity.

There are four databases and the preferred database embodiment is Oracle 9i. The Employee File Manager 200 wherein all employee records are stored, Customer File Manager 225 wherein all customer transactions are stored, Work Order Manager 240 wherein all work order records are stored, and the Tabulator 250 wherein the work order points, point ratio, equity ratio, sponsored company share price and total points accumulated, and shares outstanding are stored. The Server's modules under the control of software components perform transaction events. The user events are recorded and stored the Employee File Manager 200, Customer File Manager 225, Work Order Manager 240 and point transactions updated in the Tabulator. Auction Module 300 provides the method of a point exchange or point exchange between users. The Schedule Auction Module 400 provides employee assignments, work shift exchanges and employee point exchanges. The Scheduler 275 provides work shift schedules for all work shift classifications. The employee can request a work shift change and the Scheduler can query available employees based upon job classification and skill codes.

Therefore, the system uses transaction events to generate the user's incentives by a remote or onsite computer. The user's identification profile provides access to the server computer, the employee who is a user can be awarded value by completed work shift using the system. Furthermore, the user earns points and the user ID is updated by any point change. The point having value is converted into the system's sponsored company units or shares and the points have a certain ratio and the units have a certain unit price or stock price and the ID is updated. Customers and employees use the system to exchange the points to acquire more points or to exchange points for currency, products or services. Points are exchanged between two users where the users exchange by an auction. The auction module provides the exchange and it is recorded as a transaction event. The Scheduler is used when an employee wishes to change a work shift. The Scheduler provides the system with work shift and the method of selecting qualified users, which the system notifies, users by employee email. The employee bids on the work shift and there may be an exchange of a work shift and an exchange of points which the exchange is negotiated between two employees in the Schedule Auction Module. The ID is updated based on the user's transaction events of purchases, conversions, and exchanges, which are known by the user by executing the Sponsored Company subscription agreement or company policy. The user's transaction event are stored in the system's database known as the Work Order Manager, the Employee File Manager for employee relationship management, Customer File Manager for customer relationship management and the Tabulator for point conversion ratio, unit price, share price and point and shares outstanding.

It is claimed:

1. A system using transaction events to generate user incentives:
a host computer for transmitting a user identification profile:
a server computer under the control of software components, wherein the components comprise:
a transaction event module for generating points based upon a transaction event.
an assignment event based upon a work order offer.
a Point Exchange Module for exchanging points;
wherein the server computer updates the identification profile based upon the transaction event or point conversion.

2. The system of claim 1, wherein the software components of the server computer further comprise, a Point Conversion Module for converting points to units.

3. The system of claim 1, wherein the Point Exchange Module exchanges points for a “value” selected from the group consisting of equity, cash, product and services.

4. The system of claim 1, wherein the Point Exchange Module further comprises a Point Auction Module for selling or purchasing points.

5. The system of claim 1, further comprises a Work Shift Module wherein the work shift is an employee transaction event.

6. The system of claim 1, further comprises a Work Shift Exchange Module wherein the employee exchanges work shifts.

7. The system of claim 6, further comprises a Scheduler wherein the Scheduler identifies employee work shift and company resource availability.

8. The system of claim 6, further comprises a Schedule Auction Module wherein the employees can exchange work shifts wherein each work shift exchange represents a certain point value and resources can be exchanged within the company's enterprise.

9. The system of claim 1, wherein the database further comprises four databases the Employee File Manager, Customer File Manager, Work Order Manager and the Tabulator for employees, customers, work order management and point data storage.

10. The system in claim 1, comprises an Identification Profile (ID) wherein the ID is based upon a subscription agreement and company rules, regulations, policy and procedures.
